(19) United States
(12) Patent Application Publication
(10) Pub. No.: US 2025/0094151 A1
(43) Pub. Date: Mar. 20, 2025

(54) DEPLOYMENT OF A SERVICE

(71) Applicants: Lemon Inc., Grand Cayman (KY); Beijing Volcano Engine Technology Co., Ltd., Beijing (CN)

(72) Inventors: Shuo Liu, London (GB); Yunsi Mou, Los Angeles, CA (US); Bin Yao, Los Angeles, CA (US); Yang Yang, Los Angeles, CA (US); Yuan-Yi Wang, Los Angeles, CA (US); Yimeng Sun, Los Angeles, CA (US); Jian Wang, Beijing (CN)

(21) Appl. No.: 18/964,928

(22) Filed: Dec. 2, 2024

(51) Int. Cl. G06F 8/60

(52) U.S. Cl. CPC G06F 8/60

(57) ABSTRACT

Embodiments of the present disclosure provide a solution for deploying a service. A method includes: receiving a deployment request for deploying a service in a content delivery network (CDN) network, the deployment request at least indicating a plurality of clusters of CDN nodes where the service is to be deployed; receiving a base deployment configuration for the plurality of clusters of CDN nodes; receiving at least one deployment configuration overlay specific to at least one of the plurality of clusters of CDN nodes, a deployment configuration overlay specific to a cluster of CDN nodes indicating a delta configuration on top of the base deployment configuration that is applied to the cluster of CDN nodes; and deploying the service in the CDN network based on the base deployment configuration and the at least one deployment configuration overlay.

### FIELD

The present disclosure generally relates to computer technologies, and more specifically, to a method, apparatus, device and computer readable storage medium for deploying a service.

### BACKGROUND

With the rapid development of short video and streaming media, there is an increasing amount of short video content on the internet. At the same time, users have higher performance expectations for short video social media. To ensure that users worldwide can quickly access short video content, content delivery network (CDN) services may be used to distribute short video content to global data centers according to specific strategies, and thus service latency may be minimized, and user experience may be improved.

### SUMMARY

In a first aspect of the present disclosure, there is provided a method of deploying a service. The method comprises: receiving a deployment request for deploying a service in a content delivery network (CDN) network, the deployment request at least indicating a plurality of clusters of CDN nodes where the service is to be deployed; receiving a base deployment configuration for the plurality of clusters of CDN nodes; receiving at least one deployment configuration overlay specific to at least one of the plurality of clusters of CDN nodes, a deployment configuration overlay specific to a cluster of CDN nodes indicating a delta configuration on top of the base deployment configuration that is applied to the cluster of CDN nodes; and deploying the service in the CDN network based on the base deployment configuration and the at least one deployment configuration overlay.

In a second aspect of the present disclosure, there is provided an apparatus for video generation. The apparatus comprises: a deployment request receiving module configured to receive a deployment request for deploying a service in a content delivery network (CDN) network, the deployment request at least indicating a plurality of clusters of CDN nodes where the service is to be deployed; a base deployment configuration receiving module configured to receive a base deployment configuration for the plurality of clusters of CDN nodes; a deployment configuration overlay receiving module configured to receive at least one deployment configuration overlay specific to at least one of the plurality of clusters of CDN nodes, a deployment configuration overlay specific to a cluster of CDN nodes indicating a delta configuration on top of the base deployment configuration that is applied to the cluster of CDN nodes; and a service deploying module configured to deploy the service in the CDN network based on the base deployment configuration and the at least one deployment configuration overlay.

In a third aspect of the present disclosure, there is provided an electronic device. The electronic device comprises: at least one processing unit; and at least one memory coupled to the at least one processing unit and storing instructions executable by the at least one processing unit, the instructions, upon execution by the at least one processing unit, causing the electronic device to perform: receiving a deployment request for deploying a service in a content delivery network (CDN) network, the deployment request at least indicating a plurality of clusters of CDN nodes where the service is to be deployed; receiving a base deployment configuration for the plurality of clusters of CDN nodes; receiving at least one deployment configuration overlay specific to at least one of the plurality of clusters of CDN nodes, a deployment configuration overlay specific to a cluster of CDN nodes indicating a delta configuration on top of the base deployment configuration that is applied to the cluster of CDN nodes; and deploying the service in the CDN network based on the base deployment configuration and the at least one deployment configuration overlay.

In a fourth aspect of the present disclosure, a computer-readable storage medium is provided. The computer-readable storage medium stores computer executable instructions which, when executed by an electronic device, causes the electronic device perform operations comprising: receiving a deployment request for deploying a service in a content delivery network (CDN) network, the deployment request at least indicating a plurality of clusters of CDN nodes where the service is to be deployed; receiving a base deployment configuration for the plurality of clusters of CDN nodes; receiving at least one deployment configuration overlay specific to at least one of the plurality of clusters of CDN nodes, a deployment configuration overlay specific to a cluster of CDN nodes indicating a delta configuration on top of the base deployment configuration that is applied to the cluster of CDN nodes; and deploying the service in the CDN network based on the base deployment configuration and the at least one deployment configuration overlay.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a flowchart of a process for deploying a service in accordance with some embodiments of the present disclosure;

FIG. 3 illustrates a schematic diagram of an example of a page for initiating a deployment request in accordance with some embodiments of the present disclosure;

FIG. 4 illustrates a schematic diagram of an example of a page for setting labels in accordance with some embodiments of the present disclosure;

FIG. 5 illustrates a schematic diagram of an example of a page for showing common deployment configurations in accordance with some embodiments of the present disclosure;

FIG. 6 illustrates a schematic diagram of an example of a first deployment template in accordance with some embodiments of the present disclosure;

FIG. 7 illustrates a schematic diagram of an example of a page for presenting the plurality of options in accordance with some embodiments of the present disclosure;

FIG. 8 illustrates a schematic diagram of an example of a page for presenting states of clusters of CND nodes in accordance with some embodiments of the present disclosure;

FIG. 9 illustrates a schematic diagram of providing an updated deployment configuration in accordance with some embodiments of the present disclosure;

FIG. 10 illustrates a schematic diagram of an example process of deploying a service in accordance with some embodiments of the present disclosure;

FIG. 11 shows a block diagram of an apparatus for deploying a service in accordance with some embodiments of the present disclosure; and

FIG. 12 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

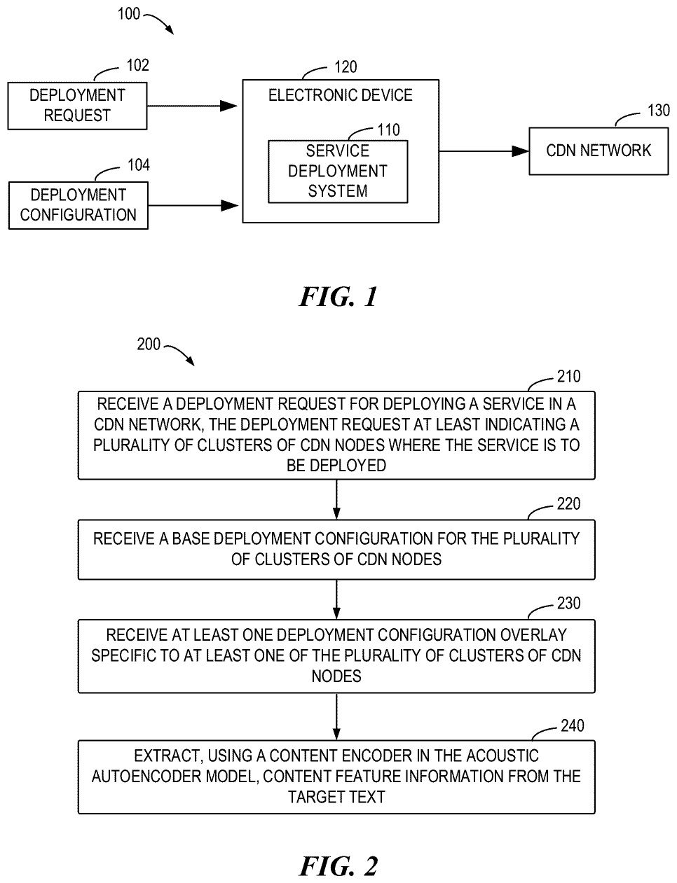

FIG. 1 illustrates a block diagram of an example environment 100 in which various embodiments of the present disclosure may be implemented. In the environment 100, an electronic device 120 includes or is deployed with a service deployment system 110. The service deployment system 110 is configured to deploy a service based on a deployment request 102 for deploying the service and a deployment configuration 104. In some embodiments, the service may be deployed in a CDN network 130, and thus is also referred to as a CDN service. As some examples, the service may include a domain name management service, a traffic scheduling service, a firewall service and the like.

In FIG. 1, the service deployment system 110 may be implemented at any computing system with computing capability, such as various computing devices/systems, terminal devices, servers, etc. Terminal devices may include any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination thereof. Servers include but are not limited to mainframe, edge computing nodes, computing devices in cloud environment, etc.

It should be understood that the structure and function of each element in the environment 100 is described for illustrative purposes only and does not imply any limitations on the scope of the present disclosure.

As mentioned above, the CDN service is used to distribute short video content to global data centers. To rapidly distribute and deploy CDN content and services to global edge nodes, achieve automated deployment updates and change management.

Some related works use a container orchestration platform for deployment. To use the container orchestration platform, users need to provide YAML files and manually maintain the associated deployment repositories. Users need to make changes and updates to the repository using a version control system, which requires them to learn how to use the container orchestration platform and manually maintain a large number of deployment files with the version control system. In addition, users need to perform deployments and subsequent maintenance using the command line and monitor the deployment status.

However, using the container orchestration platform requires manual maintenance of a large number of repetitive deployment files. When the state of the cluster changes, users need to manually maintain and update them. Users cannot automatically detect deployment changes caused by underlying resource dependencies, and there is a lack of deployment change audit management mechanisms. In addition, users need to understand how to use the container orchestration platform, there is no user interface (UI) for users, and they need to know how to use the version control system to perform deployments through code. Furthermore, in the related works, customized automated deployment generation is not considered. Data is not isolated and managed from different regions and thus data security is threatened.

Embodiments of the present disclosure propose an improved solution for deploying a service. In this solution, a deployment request for deploying a service in a content delivery network (CDN) network is received. The deployment request at least indicates a plurality of clusters of CDN nodes where the service is to be deployed. A base deployment configuration for the plurality of clusters of CDN nodes is received. At least one deployment configuration overlay specific to at least one of the plurality of clusters of CDN nodes is received. A deployment configuration overlay specific to a cluster of CDN nodes indicating a delta configuration on top of the base deployment configuration that is applied to the cluster of CDN nodes. The service is deployed in the CDN network based on the base deployment configuration and the at least one deployment configuration overlay.

With these embodiments of the present disclosure, the base deployment configuration defining fundamental configurations for all clusters and at least one deployment configuration overlay defining configuration overlays or adjustments specific to at least one cluster is received. The service may be deployed based on a combination of the base deployment configuration and at least one deployment configuration overlay. In this way, the efficiency and stability of deploying the service to different clusters may be improved.

Example embodiments of the present disclosure will be described with reference to the drawings.

FIG. 2 illustrates a flowchart of a process 200 for deploying a service in accordance with some embodiments of the present disclosure. The process 200 may be implemented at the service deployment system 110 of FIG. 1.

At block 210, the service deployment system 110 receives a deployment request 102 for deploying a service in a CDN network. The deployment request 102 at least indicates a plurality of clusters of CDN nodes where the service is to be deployed.

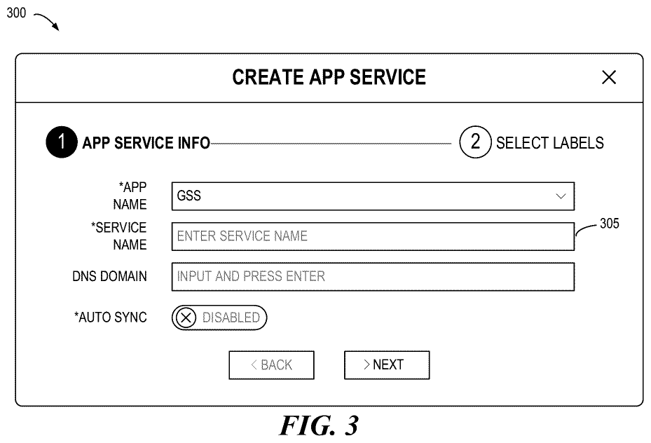

In some embodiments, a page may be provided to a user to initiate the deployment request 102 . . . . In an example, the user may be a site reliability engineer (SRE). FIG. 3 illustrates a schematic diagram of an example of a page 300 for initiating a deployment request in accordance with some embodiments of the present disclosure. As shown in FIG. 3, the deployment request 102 may include information about the service and the information may be collected through different input boxes on the page 300. In an example, the service name may be collected through an input box 305.

After collecting information about the service, the service deployment system 110 may provide a page for the user to set labels associated with deployment request 102. In some embodiments, the labels may control various aspects of deployment behavior. The labels may include settings for a plurality of clusters of CDN nodes for deploying the service, such as a plurality of clusters of CDN nodes where the service is to be deployed, deployment generation parameters, target platforms, project and the version control system integration and the like. By setting labels, the plurality of clusters of CDN nodes where the service is to be deployed may be indicated in the deployment request 102.

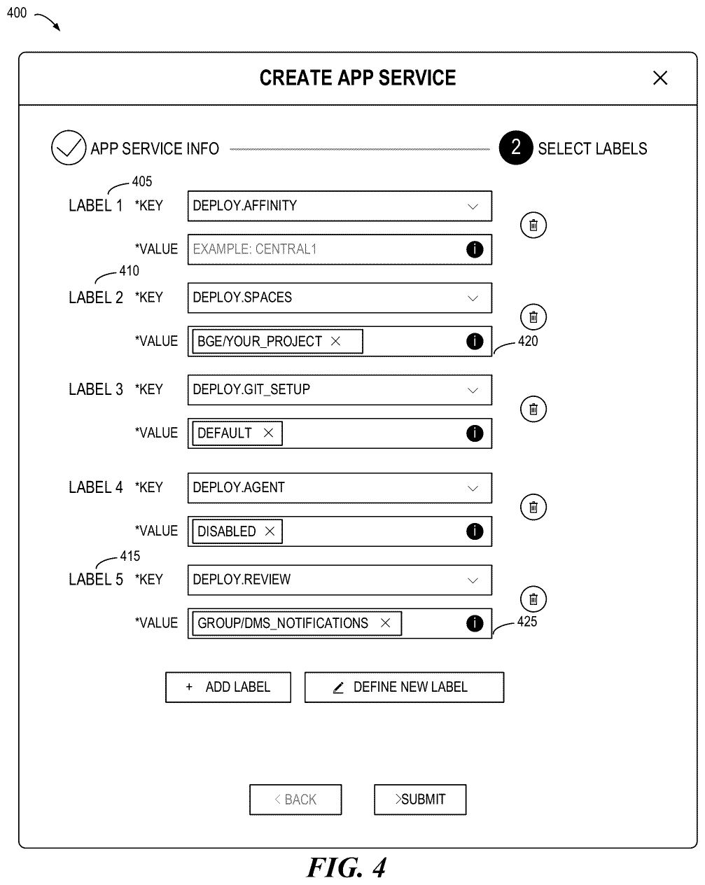

The following will describe some labels with reference to FIG. 4, which illustrates a schematic diagram of an example of a page 400 for setting labels in accordance with some embodiments of the present disclosure. As shown in FIG. 4, by setting the label 405 which includes the key as “deploy. affinity”, it may define the plurality of clusters of CDN nodes where the service is to be deployed. For example, the service may be deployed on all clusters of CDN nodes or the service may be deployed on some selected clusters of CDN nodes by setting the label 405. By setting the label 410 which includes the key as “deploy. spaces”, an account associated with resources (e.g., central processing unit (CPU), graphics processing unit (GPU), memory) owned the user may be selected. Then, the resources may be monitored during the process of deploying the service. By setting the label 415 which includes the key as “deploy. review”, when a deployment change happens, the change may be notified to the user and an approval of the change from the user may be required. In some embodiments, for some common labels for controlling deployment, the default values (e.g., value 420 and value 425) and templates may be provided on the page 400 to facilitate quick input by the user.

At block 220, the service deployment system 110 receives a base deployment configuration for the plurality of clusters of CDN nodes. In some examples, the base deployment configuration may act as a foundational setup inherited by all clusters of CDN nodes.

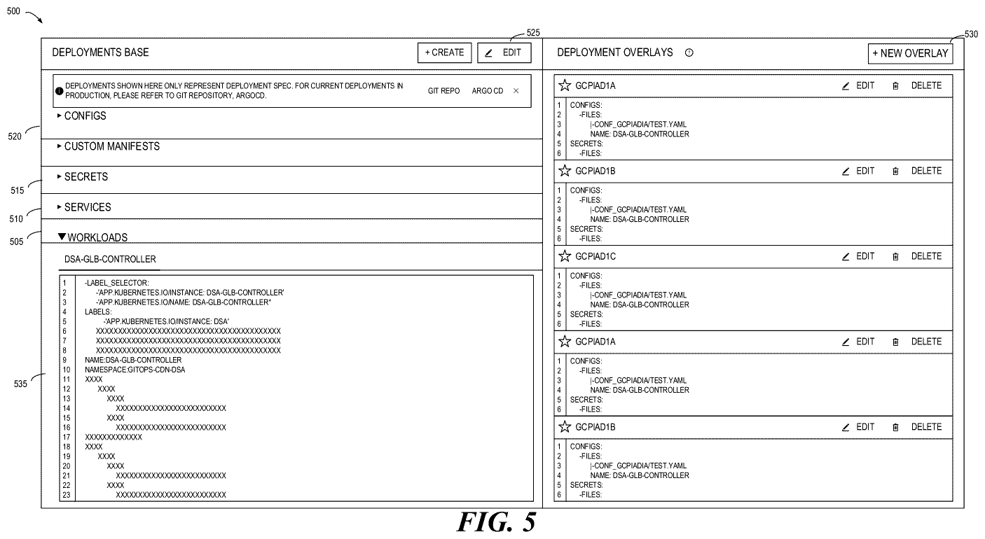

In some embodiments, common deployment configurations (e.g., deployment configurations of the container orchestration platform) including workloads, services, secrets, and configs may be extracted and displayed on a user interface. FIG. 5 illustrates a schematic diagram of an example of a page 500 for showing common deployment configurations in accordance with some embodiments of the present disclosure. As shown in FIG. 5, areas 505, 510, 515 and 520 show the extracted deployment configurations.

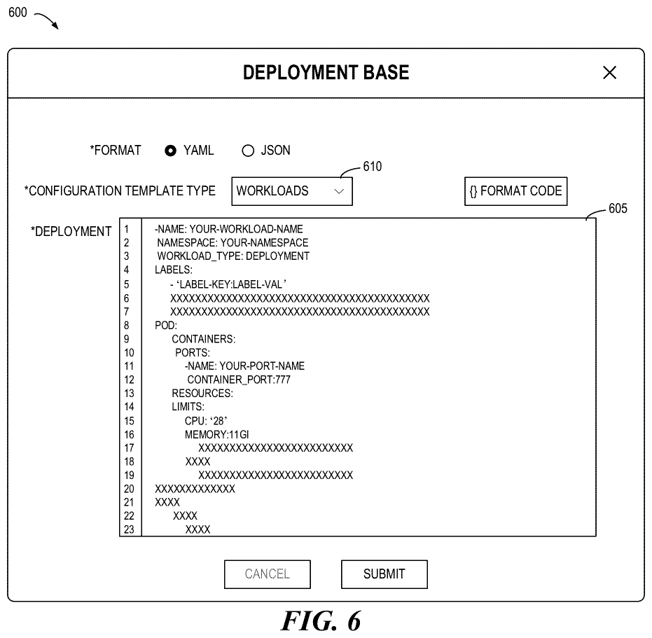

In some embodiments, in response to the deployment request, a first deployment template for the base deployment configuration may be provided on a first user interface. A plurality of configuration elements input for the plurality of first items in the first deployment template may be received respectively to obtain the base deployment configuration. In the example of FIG. 5, in response to a trigger on a button 525, the first deployment template is provided. FIG. 6 illustrates a schematic diagram of an example of a first deployment template 600 in accordance with some embodiments of the present disclosure. As shown in FIG. 6, in an area 605 of the first deployment template 600, configuration elements input for first items (e.g., container port at the 12th line and CPU at the 15th line).

In some embodiments, the first deployment template 600 is provided according to a type of the service. Different first deployment templates may be provided to different types of the service (e.g., workloads, services, secrets, and configs), respectively. In the example of FIG. 6, the type of the service may be received by triggering a selection box 610.

After the base deployment configuration is received, at block 230, the service deployment system 110 receives at least one deployment configuration overlay specific to at least one of the plurality of clusters of CDN nodes. A deployment configuration overlay specific to a cluster(s) of CDN nodes indicates a delta configuration on top of the base deployment configuration that is applied to the cluster(s) of CDN nodes. In some examples, the deployment configuration overlay specific to a cluster represents changes (also referred to as the delta configuration) applied to the specific cluster. If the deployment configuration overlay is the same as the base deployment configuration, the delta configuration is zero.

In some embodiments, a second deployment template for a deployment configuration overlay corresponding to the cluster of CDN nodes may be provided on a second user interface. The second deployment template indicates a plurality of second items to be collected for the deployment configuration overlay. Furthermore, a plurality of configuration elements input for the plurality of second items (e.g., ports, CPU, memory) may be received in the second deployment template, respectively, to obtain the deployment configuration overlay. In the example of FIG. 5, in response to a trigger on a button 530, a second deployment template may be provided. The second deployment template may be similar to the first deployment template 600. In some examples, the configuration elements input for the second items collected in the second deployment template may modify the configuration elements input for the first items in the first deployment template 600.

In some embodiments, the service deployment system 110 may automate the generation of deployment configurations based on the received base deployment configuration and/or the deployment configuration overlay(s). In this way, manual effort required to create and maintain the files for deploying the service may be reduced.

In some embodiments, the first or second deployment template may be determined by a user initiating the deployment request. The user may be allowed to upload customized deployment template. The plurality of first or second items are presented with corresponding default values in the first or second deployment template. In an example, default values may be provided in the first or second deployment template, where actual values of these variables (e.g., first items or second items) vary depending on the deployment environment. Furthermore, at least one updated value input by the user for at least one of the plurality of first or second items. The at least one updated value input may replace the default values.

In some embodiments, in response to a selection of a first configuration mode (also referred to as advance mode), an input box for at least one of the plurality of first or second items is provided, to receive input information related to the at least one of the plurality of first items or second items. Reference is made back to FIG. 5, an input box 535 is provided to receive input information related to the at least one of the plurality of first items or second items. In some examples, the user may be enabled to edit the JSON/YAML file related to the first deployment template or the second deployment template. In addition, code beautification tools may be provided, which caters to users familiar with the container orchestration platform who have specific requirements. In this way, complete modifications to deployment configurations are achieved, which provides users with powerful and flexible deployment capabilities.

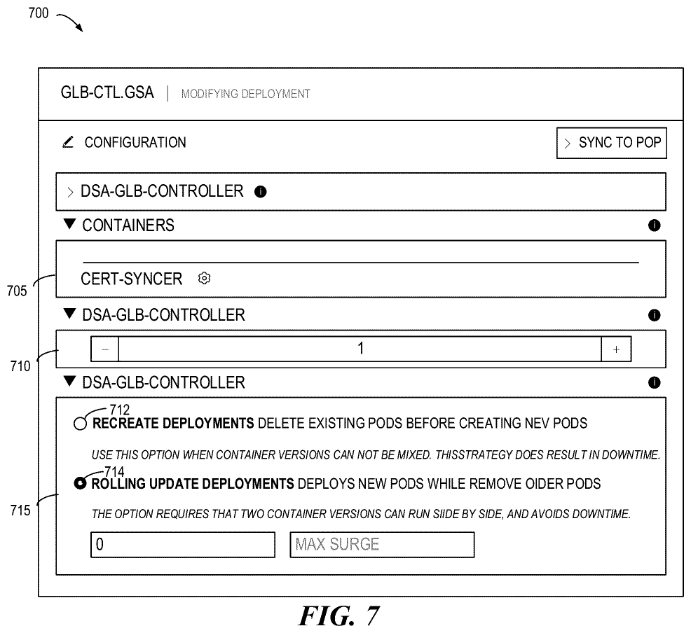

In some embodiments, in response to a selection of a second configuration mode (also referred to as quick mode), a plurality of options for at least one of the plurality of first or second items to may be provided to receive input information related to the at least one of the plurality of first items or second items. This mode enables users to make common changes swiftly. For example, users may easily modify an image of a container or adjust the number of replicas without delving into complex configurations. The plurality of options may be presented on a page on the user interface for the user to select. FIG. 7 illustrates a schematic diagram of an example of a page 700 for presenting the plurality of options in accordance with some embodiments of the present disclosure. As shown in FIG. 7, the image of the container may be selected from plurality of options for images (not shown) in the area 705. The number of replicas may be adjusted in the area 710. The update strategy for a deployment configuration may be selected from plurality of options (e.g., the option 712 and option 714) in the area 715. In this way, quick modifications for common operations such as updating images and adjusting the number of replicas may be supported, which enables users unfamiliar with the container orchestration platform to quickly perform operations and maintenance tasks, facilitating ease of use and rapid deployment.

After the at least one deployment configuration overlay is received, at block 240, the service deployment system 110 deploys the service in the CDN network based on the base deployment configuration and the at least one deployment configuration overlay. When combined with the base deployment configuration, deployment configuration overlays modify or enhance the base deployment configuration for respective clusters. The service may be deployed in the CDN network based on a combination of the base deployment configuration and the at least one deployment configuration overlay.

In some embodiments, the base deployment configuration comprises a plurality of placeholders for a plurality of parameters respectively. For each of the at least one deployment configuration overlay, a combined deployment configuration may be generated by at least replacing the plurality of placeholders in the base deployment configuration with a plurality of values for the plurality of parameters as specified in the deployment configuration overlay. The plurality of placeholders may be dynamically changed based on the deployment environment (e.g., the deployment configuration overlay) and the plurality of values for the plurality of parameters may be customized by the user. By replacing the plurality of placeholders with the plurality of values for the plurality of parameters, a deployable YAML configuration (as an example of the combined deployment configuration) may be generated. It is to be noted that the combined deployment configuration may be in the form of other configuration files and the scope of the present disclosure is not limited in this regard.

After the combined deployment configuration is generated, the service may be deployed based on at least one of the combined deployment configuration for the at least one deployment configuration overlay. In this way, users may customize injected values in configurations, which enhances deployment flexibility, efficiency, and reduces deployment repetition.

In some embodiments, the base deployment configuration and the at least one deployment configuration overlay may be specific to a target region and the service may be deployed into at least a part of the CDN network associated with the target region. To support independent deployment and operation in a plurality of compliant regions, service deployment may be separated based on these regions. Each region has its independent database and service deployment instances, which are maintained separately. For example, a service deployed in the United States operates independently, and is maintained and managed by a US operations team, which ensures security and isolation of data for US users. In this way, compliance requirements may be met, and data security and operational efficiency may be maintained across different regions.

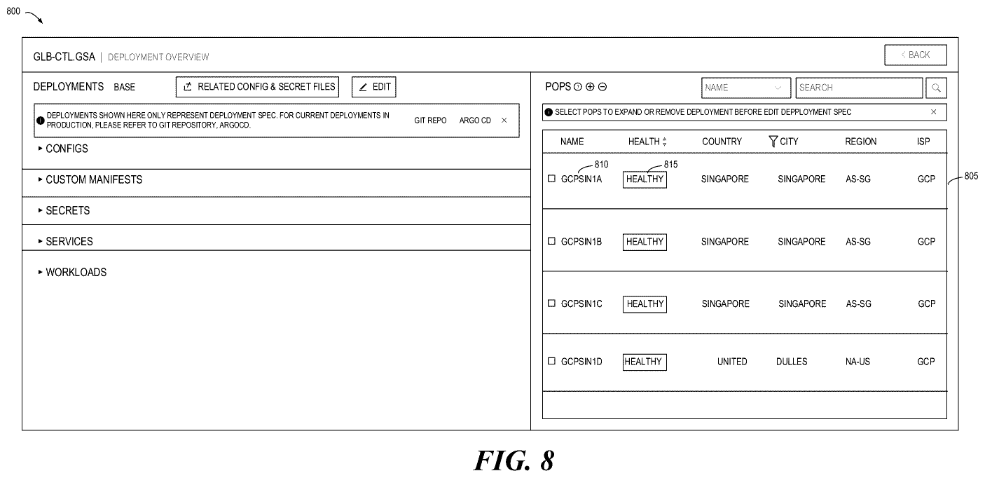

In some embodiments, respective states of the plurality of clusters of CND nodes are presented in the first user interface or the second user interface. In some examples, deployment statuses, including the states of deployed nodes and the overall health of the deployments may be displayed on the user interface. FIG. 8 illustrates a schematic diagram of an example of a page 800 for presenting states of clusters of CND nodes in accordance with some embodiments of the present disclosure. As shown in FIG. 8, in area 805, the state of the CDN node 810 and the healthy status 815 of the CDN node 810 are shown. In this way, users are enabled to manage and monitor the status of the deployment through the user interface, thereby providing insights into their performance and status.

In some embodiments, in response to a detection of a resource for deploying the service being modified, at least one of the base deployment configuration or the at least one deployment configuration overlay may be updated. The updated at least one of the base deployment configuration or the at least one deployment configuration overlay may be provided to the user. The resource for deploying the service may be modified by the user or modified automatically on a resource platform.

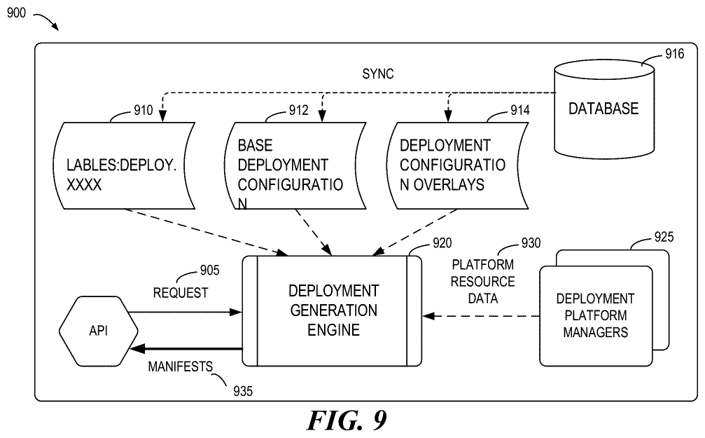

FIG. 9 illustrates a schematic diagram 900 of providing an updated deployment configuration in accordance with some embodiments of the present disclosure. As shown in FIG. 9, a user may send a request 905 to modify the resource for deploying the service (e.g., labels 910, a base deployment configuration 912 and deployment configuration overlays 914 stored in a database 916), by operating through the user interface, to a deployment generation engine 920. Furthermore, a deployment platform manager 925 (as an example of the resource platform) may send platform resource data 930 to the deployment generation engine 920 to notify the resource is modified automatically (e.g., when a node goes offline). As a result, the deployment generation engine 920 (as a component of the service deployment system 905) may update at least one of the base deployment configuration or the at least one deployment configuration overlay, and provide manifests 935 (which may include the updated at least one of the base deployment configuration or the at least one deployment configuration overlay) to the user. In some examples, the user may check the deployment difference and decide whether to apply the change. In this way, relevant parties may be informed promptly when deployment of deployed services changes, the stability and reliability of the deployed services may be ensured.

In some embodiments, in response to receiving a configuration of the updated at least one of the base deployment configuration or the at least one deployment configuration overlay, the service deployment system 905 may update a deployment of the service in the CDN network based on the updated at least one of the base deployment configuration or the at least one deployment configuration overlay. In this way, manual changes to the base deployment configuration or deployment configuration overlay made by the user may be avoided, thereby improving the efficiency of deploying the service.

In some embodiments, the service deployment system 110 may be able to identify which platforms possess deployable resources available for deployment by integrating with a resource platform. This integration allows the service deployment system 110 to efficiently determine and utilize resources across different platforms, ensuring optimal deployment management and resource allocation based on platform capabilities and availability.

In some embodiments, the service deployment system 110 may provide functionalities such as automated deployment generation, dynamic deployment changes, change risk management, and deployment stability observation, enhancing deployment efficiency, reducing engineers' workload, and improving service stability. The service deployment system 110 allows users who are unfamiliar with the container orchestration platform to quickly deploy using the user interface. Additionally, for deployment changes, it quickly generates deployment configurations. To segregate user data from different regions, the service deployment system 110 adopts a multi-region deployment architecture, supporting the data compliance needs of different regions.

In some embodiments, the service deployment system 110 may provide a user interface that consolidates all deployment operations into a single interface. In some examples, users may perform all necessary operations from a single page within the user interface. Users may be enabled to create the service seamlessly. Injection of templates may be supported, thereby enhancing flexibility and standardization in deployment configurations. Centralized management of configurations associated with deployments may be supported. Efficient management of deployments may be allowed, including initiation, monitoring, and modification of the deployments. Real-time status updates on deployments may be provided, which ensures visibility into their current state. The review and approval of deployment changes may be supported, which prompts the controlled and auditable updates. Overall, the service deployment system 110 reduces the time and effort required for engineers to onboard new deployments and manage ongoing operations, offering a user-friendly alternative to traditional terminal-based or API-driven approaches.

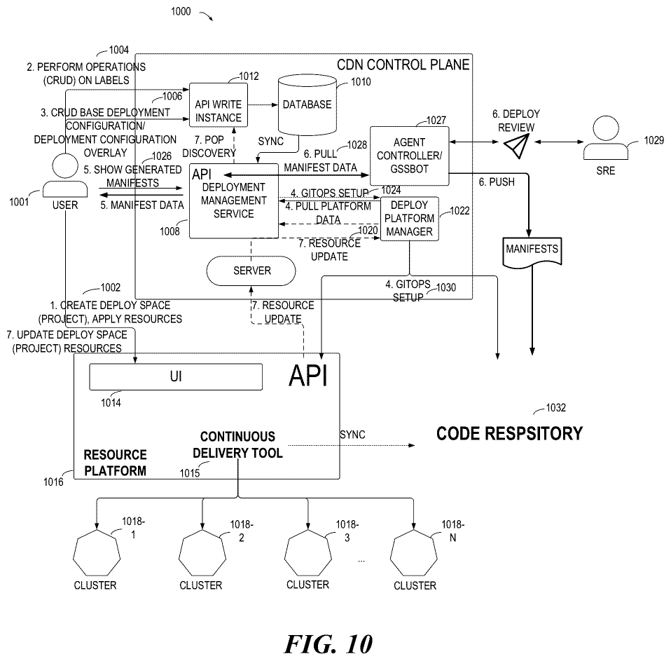

FIG. 10 illustrates a schematic diagram 1000 of an example process of deploying a service in accordance with some embodiments of the present disclosure. At 1002, a user 1001 (e.g., SRE) may create a deploy space (e.g., a resource account) and apply resources through a user interface 1014 of a continuous delivery tool 1015 running on a resource platform 1016. The resource platform 1015 may manage a plurality of clusters of CDN nodes 1018-1 to 1018-N. The deploy space may be a label associated with deployment of the service, by creating the deploy space, resources for deploying the service may be applied. At 1004, the user 1001 may perform operations (e.g., create, read, update and delete) on labels associated with deploying the service. At 1006, the user 1001 may perform operations (e.g., create, read, update and delete) on a base deployment configuration or at least one deployment configuration overlay.

A deployment management service 1008 (as a component of the service deployment system 110) may store labels, the base deployment configuration and at least one deployment configuration overlay to a database 1010 through a write instance 1012. The deployment management service 1008 and the database 1010 need to be synchronized. At 1020, when resources are updated, the update may be reflected on a deploy platform manager 1022 (as an example of a resource management system). At 1024, the deploy platform manager 1022 may notify the update of the resource to the deployment management service 1008. At 1026, the user 1001 may request manifest data (e.g., base deployment configuration or deployment configuration overlay) from the deployment management service 1008 and the generated manifest data may be shown to the user 1001. At 1028, an agent controller may continuously pull manifest data from the deployment management service 1008. If the manifest data is changed, this change may be notified to a SRE 1029. Furthermore, at 1030, when a project is created on the resource platform 1016, related resources, repositories, folders in the repositories may be generated on a code repository 1032, and thus the workload of a user may be reduced.

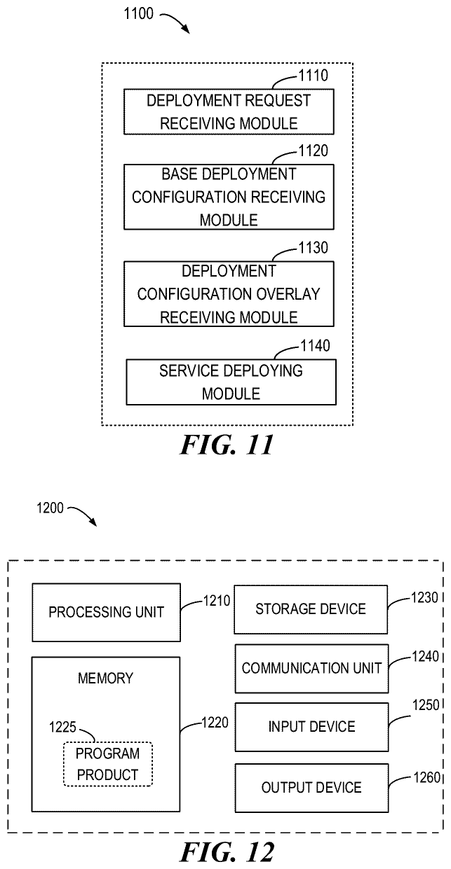

FIG. 11 shows a block diagram of an apparatus 1100 for deploying a service in accordance with some embodiments of the present disclosure. The apparatus 1100 may be implemented, for example, or included at the service deployment system 110 of FIG. 1. Various modules/components in the apparatus 1100 may be implemented by hardware, software, firmware, or any combination thereof.

As illustrated, the apparatus 1100 includes a deployment request receiving module 1110 configured to receive a deployment request for deploying a service in a content delivery network (CDN) network, the deployment request at least indicating a plurality of clusters of CDN nodes where the service is to be deployed.

The apparatus 1100 includes a base deployment configuration receiving module 1120 configured to receive a base deployment configuration for the plurality of clusters of CDN nodes.

The apparatus 1100 includes a deployment configuration overlay receiving module 1130 configured to receive at least one deployment configuration overlay specific to at least one of the plurality of clusters of CDN nodes, a deployment configuration overlay specific to a cluster of CDN nodes indicating a delta configuration on top of the base deployment configuration that is applied to the cluster of CDN nodes.

The apparatus 1100 further includes a service deploying module 1140 configured to deploy the service in the CDN network based on the base deployment configuration and the at least one deployment configuration overlay.

In some embodiments, the base deployment configuration receiving module 1120 is further configured to, in response to the deployment request, provide a first deployment template for the base deployment configuration on a first user interface, the first deployment template indicating a plurality of first items to be collected for the base deployment configuration; and receive a plurality of configuration elements input for the plurality of first items in the first deployment template, respectively, to obtain the base deployment configuration. The deployment configuration overlay receiving module 1130 is further configured to, for each of the at least one cluster of the plurality of CDN nodes, provide a second deployment template for a deployment configuration overlay corresponding to the cluster of CDN nodes on a second user interface, the second deployment template indicating a plurality of second items to be collected for the deployment configuration overlay; and receive a plurality of configuration elements input for the plurality of second items in the second deployment template, respectively, to obtain the deployment configuration overlay.

In some embodiments, the first or second deployment template is determined by a user initiating the deployment request, and the plurality of first or second items being presented with corresponding default values in the first or second deployment template. The base deployment configuration receiving module 1120 or the deployment configuration overlay receiving module 1130 is further configured to receive at least one updated value input by the user for at least one of the plurality of first or second items.

In some embodiments, the base deployment configuration receiving module 1120 or the deployment configuration overlay receiving module 1130 is further configured to, in response to a selection of a first configuration mode, provide an input box for at least one of the plurality of first or second items, to receive input information related to the at least one of the plurality of first items or second items; or in response to a selection of a second configuration mode, provide a plurality of options for at least one of the plurality of first or second items to receive input information related to the at least one of the plurality of first items or second items.

In some embodiments, the apparatus 1100 further includes a deployment updating module configured to, in response to a detection of a resource for deploying the service being modified, update at least one of the base deployment configuration or the at least one deployment configuration overlay; provide the updated at least one of the base deployment configuration or the at least one deployment configuration overlay to the user; and in response to receiving a configuration of the updated at least one of the base deployment configuration or the at least one deployment configuration overlay, update a deployment of the service in the CDN network based on the updated at least one of the base deployment configuration or the at least one deployment configuration overlay.

In some embodiments, respective states of the plurality of clusters of CND nodes are presented in the first user interface or the second user interface.

In some embodiments, the base deployment configuration comprises a plurality of placeholders for a plurality of parameters respectively and the service deploying module 1140 is further configured to, for each of the at least one deployment configuration overlay, generate a combined deployment configuration by at least replacing the plurality of placeholders in the base deployment configuration with a plurality of values for the plurality of parameters as specified in the deployment configuration overlay; and deploy the service in the CDN network based on at least one of the combined deployment configuration for the at least one deployment configuration overlay.

In some embodiments, the base deployment configuration and the at least one deployment configuration overlay are specific to a target region and the service deploying module 1140 is further configured to deploy the service into at least a part of the CDN network associated with the target region.

FIG. 12 illustrates a block diagram of an electronic device 1200 in which one or more embodiments of the present disclosure can be implemented. It would be appreciated that the electronic device 1200 shown in FIG. 12 is only an example and should not constitute any restriction on the function and scope of the embodiments described herein. The electronic device 1200 may be used, for example, to implement the service deployment system 110 of FIG. 1. The electronic device 1200 may also be used to implement the apparatus 1100 of FIG. 11.

As shown in FIG. 12, the electronic device 1200 is in the form of a general computing device. The components of the electronic device 1200 may include, but are not limited to, one or more processors or processing units 1210, a memory 1220, a storage device 1230, one or more communication units 1240, one or more input devices 1250, and one or more output devices 1260. The processing unit 1210 may be an actual or virtual processor and can execute various processes according to the programs stored in the memory 1220. In a multiprocessor system, multiple processing units execute computer executable instructions in parallel to improve the parallel processing capability of the electronic device 1200.

The electronic device 1200 typically includes a variety of computer storage medium. Such medium may be any available medium that is accessible to the electronic device 1200, including but not limited to volatile and non-volatile medium, removable and non-removable medium. The memory 1220 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 1230 may be any removable or non-removable medium, and may include a machine-readable medium, such as a flash drive, a disk, or any other medium, which can be used to store information and/or data (such as training data for training) and can be accessed within the electronic device 1200.

The electronic device 1200 may further include additional removable/non-removable, volatile/non-volatile, transitory/non-transitory storage medium. Although not shown in FIG. 12, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 1220 may include a computer program product 1225, which has one or more program modules configured to perform various methods or acts of various embodiments of the present disclosure.

The communication unit 1240 communicates with a further computing device through the communication medium. In addition, functions of components in the electronic device 1200 may be implemented by a single computing cluster or multiple computing machines, which can communicate through a communication connection. Therefore, the electronic device 1200 may be operated in a networking environment using a logical connection with one or more other servers, a network personal computer (PC), or another network node.

The input device 1250 may be one or more input devices, such as a mouse, a keyboard, a trackball, etc. The output device 1260 may be one or more output devices, such as a display, a speaker, a printer, etc. The electronic device 1200 may also communicate with one or more external devices (not shown) through the communication unit 1240 as required. The external device, such as a storage device, a display device, etc., communicate with one or more devices that enable users to interact with the electronic device 1200, or communicate with any device (for example, a network card, a modem, etc.) that makes the electronic device 1200 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

1. A method of deploying a service, comprising:
receiving a deployment request for deploying a service in a content delivery network (CDN) network, the deployment request at least indicating a plurality of clusters of CDN nodes where the service is to be deployed;
receiving a base deployment configuration for the plurality of clusters of CDN nodes;
receiving at least one deployment configuration overlay specific to at least one of the plurality of clusters of CDN nodes, a deployment configuration overlay specific to a cluster of CDN nodes indicating a delta configuration on top of the base deployment configuration that is applied to the cluster of CDN nodes; and
deploying the service in the CDN network based on the base deployment configuration and the at least one deployment configuration overlay.

2. The method of claim 1, wherein receiving the base deployment configuration comprises:
in response to the deployment request, providing a first deployment template for the base deployment configuration on a first user interface, the first deployment template indicating a plurality of first items to be collected for the base deployment configuration; and
receiving a plurality of configuration elements input for the plurality of first items in the first deployment template, respectively, to obtain the base deployment configuration; and/or
wherein receiving the at least one deployment configuration overlay comprises: for each of the at least one cluster of the plurality of CDN nodes,
providing a second deployment template for a deployment configuration overlay corresponding to the cluster of CDN nodes on a second user interface, the second deployment template indicating a plurality of second items to be collected for the deployment configuration overlay; and
receiving a plurality of configuration elements input for the plurality of second items in the second deployment template, respectively, to obtain the deployment configuration overlay.

3. The method of claim 2, wherein the first or second deployment template is determined by a user initiating the deployment request, and the plurality of first or second items being presented with corresponding default values in the first or second deployment template, and
wherein receiving the plurality of configuration elements input for the plurality of first or second items respectively comprises:
receiving at least one updated value input by the user for at least one of the plurality of first or second items.

4. The method of claim 2, wherein providing the first deployment template or the second deployment template comprises at least one of:
in response to a selection of a first configuration mode, providing an input box for at least one of the plurality of first or second items, to receive input information related to the at least one of the plurality of first items or second items; or
in response to a selection of a second configuration mode, providing a plurality of options for at least one of the plurality of first or second items to receive input information related to the at least one of the plurality of first items or second items.

5. The method of claim 1, further comprising:
in response to a detection of a resource for deploying the service being modified, updating at least one of the base deployment configuration or the at least one deployment configuration overlay;
providing the updated at least one of the base deployment configuration or the at least one deployment configuration overlay to the user; and
in response to receiving a configuration of the updated at least one of the base deployment configuration or the at least one deployment configuration overlay, updating a deployment of the service in the CDN network based on the updated at least one of the base deployment configuration or the at least one deployment configuration overlay.

6. The method of claim 2, wherein respective states of the plurality of clusters of CND nodes are presented in the first user interface or the second user interface.

7. The method of claim 1, wherein the base deployment configuration comprises a plurality of placeholders for a plurality of parameters respectively and wherein deploying the service in the CDN network comprises:
for each of the at least one deployment configuration overlay, generating a combined deployment configuration by at least replacing the plurality of placeholders in the base deployment configuration with a plurality of values for the plurality of parameters as specified in the deployment configuration overlay; and
deploying the service in the CDN network based on at least one of the combined deployment configuration for the at least one deployment configuration overlay.

8. The method of claim 1, wherein the base deployment configuration and the at least one deployment configuration overlay are specific to a target region, and wherein deploying the service in the CDN network comprises:
deploying the service into at least a part of the CDN network associated with the target region.

9. An electronic device, comprising:
at least one processing unit; and
at least one memory coupled to the at least one processing unit and storing instructions executable by the at least one processing unit, the instructions, upon execution by the at least one processing unit, causing the electronic device to perform operations comprising:
receiving a deployment request for deploying a service in a content delivery network (CDN) network, the deployment request at least indicating a plurality of clusters of CDN nodes where the service is to be deployed;
receiving a base deployment configuration for the plurality of clusters of CDN nodes;
receiving at least one deployment configuration overlay specific to at least one of the plurality of clusters of CDN nodes, a deployment configuration overlay specific to a cluster of CDN nodes indicating a delta configuration on top of the base deployment configuration that is applied to the cluster of CDN nodes; and
deploying the service in the CDN network based on the base deployment configuration and the at least one deployment configuration overlay.

10. The electronic device of claim 9, wherein receiving the base deployment configuration comprises:
in response to the deployment request, providing a first deployment template for the base deployment configuration on a first user interface, the first deployment template indicating a plurality of first items to be collected for the base deployment configuration; and
receiving a plurality of configuration elements input for the plurality of first items in the first deployment template, respectively, to obtain the base deployment configuration; and/or
wherein receiving the at least one deployment configuration overlay comprises: for each of the at least one cluster of the plurality of CDN nodes,
providing a second deployment template for a deployment configuration overlay corresponding to the cluster of CDN nodes on a second user interface, the second deployment template indicating a plurality of second items to be collected for the deployment configuration overlay; and
receiving a plurality of configuration elements input for the plurality of second items in the second deployment template, respectively, to obtain the deployment configuration overlay.

11. The electronic device of claim 10, wherein the first or second deployment template is determined by a user initiating the deployment request, and the plurality of first or second items being presented with corresponding default values in the first or second deployment template, and
wherein receiving the plurality of configuration elements input for the plurality of first or second items respectively comprises:
receiving at least one updated value input by the user for at least one of the plurality of first or second items.

12. The electronic device of claim 10, wherein providing the first deployment template or the second deployment template comprises at least one of:
in response to a selection of a first configuration mode, providing an input box for at least one of the plurality of first or second items, to receive input information related to the at least one of the plurality of first items or second items; or
in response to a selection of a second configuration mode, providing a plurality of options for at least one of the plurality of first or second items to receive input information related to the at least one of the plurality of first items or second items.

13. The electronic device of claim 9, the operations further comprising:
in response to a detection of a resource for deploying the service being updated, modifying at least one of the base deployment configuration or the at least one deployment configuration overlay;
providing the updated at least one of the base deployment configuration or the at least one deployment configuration overlay to the user; and
in response to receiving a configuration of the updated at least one of the base deployment configuration or the at least one deployment configuration overlay, updating a deployment of the service in the CDN network based on the updated at least one of the base deployment configuration or the at least one deployment configuration overlay.

14. The electronic device of claim 10, wherein respective states of the plurality of clusters of CND nodes are presented in the first user interface or the second user interface.

15. The electronic device of claim 9, wherein the base deployment configuration comprises a plurality of placeholders for a plurality of parameters respectively and wherein deploying the service in the CDN network comprises:
for each of the at least one deployment configuration overlay, generating a combined deployment configuration by at least replacing the plurality of placeholders in the base deployment configuration with a plurality of values for the plurality of parameters as specified in the deployment configuration overlay; and
deploying the service in the CDN network based on at least one of the combined deployment configuration for the at least one deployment configuration overlay.

16. The electronic device of claim 9, wherein the base deployment configuration and the at least one deployment configuration overlay are specific to a target region, and wherein deploying the service in the CDN network comprises:
deploying the service into at least a part of the CDN network associated with the target region.

17. A non-transitory computer readable storage medium having computer executable instructions stored thereon, the computer executable instructions, when executed by an electronic device, causing the electronic device perform operations comprising:
receiving a deployment request for deploying a service in a content delivery network (CDN) network, the deployment request at least indicating a plurality of clusters of CDN nodes where the service is to be deployed;
receiving a base deployment configuration for the plurality of clusters of CDN nodes;
receiving at least one deployment configuration overlay specific to at least one of the plurality of clusters of CDN nodes, a deployment configuration overlay specific to a cluster of CDN nodes indicating a delta configuration on top of the base deployment configuration that is applied to the cluster of CDN nodes; and
deploying the service in the CDN network based on the base deployment configuration and the at least one deployment configuration overlay.

18. The non-transitory computer readable storage medium of claim 17, wherein receiving the base deployment configuration comprises:
in response to the deployment request, providing a first deployment template for the base deployment configuration on a first user interface, the first deployment template indicating a plurality of first items to be collected for the base deployment configuration; and
receiving a plurality of configuration elements input for the plurality of first items in the first deployment template, respectively, to obtain the base deployment configuration; and/or
wherein receiving the at least one deployment configuration overlay comprises: for each of the at least one cluster of the plurality of CDN nodes,
providing a second deployment template for a deployment configuration overlay corresponding to the cluster of CDN nodes on a second user interface, the second deployment template indicating a plurality of second items to be collected for the deployment configuration overlay; and
receiving a plurality of configuration elements input for the plurality of second items in the second deployment template, respectively, to obtain the deployment configuration overlay.

19. The non-transitory computer readable storage medium of claim 18, wherein the first or second deployment template is determined by a user initiating the deployment request, and the plurality of first or second items being presented with corresponding default values in the first or second deployment template, and
wherein receiving the plurality of configuration elements input for the plurality of first or second items respectively comprises:
receiving at least one updated value input by the user for at least one of the plurality of first or second items.

20. The non-transitory computer readable storage medium of claim 18, wherein providing the first deployment template or the second deployment template comprises at least one of:
in response to a selection of a first configuration mode, providing an input box for at least one of the plurality of first or second items, to receive input information related to the at least one of the plurality of first items or second items; or
in response to a selection of a second configuration mode, providing a plurality of options for at least one of the plurality of first or second items to receive input information related to the at least one of the plurality of first items or second items.
